(19) United States
(12) Patent Application Publication
(10) Pub. No.: US 2026/0149682 A1
(43) Pub. Date: May 28, 2026

(54) METHOD AND SYSTEM FOR PROVIDING DIGITAL CONTENT WITHIN A DIGITAL CONVERSATION BASED ON MESSAGES WITHIN THE CONVERSATION

(71) Applicant: SNIBBLE CORP., Toronto (CA)

(72) Inventor: Andrew Keith SHORTT, Toronto (CA)

(21) Appl. No.: 18/962,594

(22) Filed: Nov. 27, 2024

(51) Int. Cl. H04L 51/10; G06F 3/0482; G06F 40/35

(52) U.S. Cl. CPC H04L 51/10; G06F 3/0482; G06F 40/35

(57) ABSTRACT

The disclosure is directed at a method and system for providing digital content within a digital conversation based on messages within the conversation. As messages are transmitted back and forth within the digital conversation, the messages are processed using natural language processing to determine a context or content of the messages. Digital content related to the determined context or content is then retrieved by the system and automatically embedded into the digital conversation.

### FIELD

The disclosure is generally directed at digital communications and, more specifically, at a system and method for providing digital content within a digital conversation based on messages within the conversation.

### BACKGROUND

Use of technology to communicate between individuals is growing on a daily basis. These communications generally involve two or more parties using their smartphone, tablet, laptop or desktop computer to communicate with other parties. In some examples, the communications can be via a posting on a social media platform so that other individuals can view these postings at a convenient time. Another form of digital communication is to have online digital conversations with each other. In some embodiments, these digital conversations may occur in real-time.

In these digital conversations, which may or may not take place within a messaging platform, there may be occasion where an individual wishes to share digital content (from another social media platform) to the other parties of the conversation. This requires the individual to leave the conversation, access the other social media platform to obtain a link to the digital media content or the digital media content itself and then return to conversation to embed or integrate the link to or the digital media content into the conversation. All of this can be time consuming and requires the individual to leave the conversation to access the other social medial platform or platforms.

Therefore, there is provided a novel method and system for providing digital content within a digital conversation based on messages within the conversation.

### BRIEF DESCRIPTION OF THE DRAWINGS

Embodiments of the present disclosure will now be described, by way of example only, with reference to the attached Figures.

FIG. 1 is a schematic diagram of a system for providing digital content within a digital conversation based on messages within the conversation in an operational environment;

FIG. 2 is a schematic diagram of the system for providing digital content;

FIG. 3a is a schematic diagram of a method of providing digital content within a digital conversation based on messages within the conversation;

FIG. 3b is a schematic diagram of another method of providing digital content within a digital conversation based on messages within the conversation;

FIG. 4 is a flowchart showing yet a further method of providing digital content within a digital conversation based on messages within the conversation; and

FIGS. 5a to 5d are different screenshots that are displayed by a system for providing digital content within a digital conversation based on messages within the conversation.

### SUMMARY

In one aspect of the disclosure, there is provided a method for providing digital content within a digital conversation based on messages within the digital conversation including processing a selected message within the digital conversation using natural language processing (NLP) to determine a context or content of the selected message; retrieving digital content associated with the context or content of the selected message; and embedding the digital content into the digital conversation.

In another aspect, embedding the digital content into the digital conversation includes providing a list of the digital content to an individual associated with the selected message; receiving a selection of digital content from the list of the digital content; and integrating the selected digital content into the digital conversation. In a further aspect, processing a selected message includes saving each message within the digital conversation; assigning a message identification for each message; receiving a request to process a message based on the message identification; and processing the identified message using NLP. In yet another aspect, embedding the digital content into the digital conversation includes playing the embedded digital content within the digital conversation. In yet a further aspect, embedding the digital content into the digital conversation includes integrating the embedded digital content within the digital conversation. In an aspect, retrieving digital content associated with the context or content of the selected message includes accessing a server storing digital content associated with the context or content of the selected message; requesting the digital content from the server; and receiving the digital content from the server. In a further aspect, the digital content is at least one of video content; digital content; jpegs; memes; or gifs.

### DETAILED DESCRIPTION

The disclosure is directed at a method and system for providing digital content, or digital media content, within a digital conversation that is based on messages within the conversation. In some embodiments, the disclosure may be seen as a method and system for artificial intelligence (AI) powered conversations. In some embodiments, the disclosure processes messages within an online or digital conversation to determine a content and/or context of the messages which may result in a determination of search terms. The message processing may be performed automatically or may be performed when requested by an individual who has typed the message within the conversation. In some embodiments, the disclosure then searches a database, local or remote, to retrieve digital content or digital media content, that relates to or is associated with the determined context or content or search terms. In other embodiments, the disclosure may communicate with external servers or databases that have digital content stored within to determine if these external servers or databases have digital content that is relevant to the determined context, content or search terms. In some embodiments, the external servers or databases are associated with different social media platforms.

If located, the system then embeds the digital content into the conversation, either through a recommendation section or tab to the individual who typed the message or directly into the conversation.

In some embodiments, the system may be integrated within a messaging platform that provides the functionality for conversations to be enabled between at least two individuals using the messaging platform. In these embodiments, by having the system or method of the disclosure integrated within the messaging platform provides more flexibility for processing of the messages within a conversation and to integrate the digital content within the conversation. In these embodiments, all of the messages from a conversation may be saved to a database or server and the system of the disclosure accesses the stored messages rather than processing real-time messages within a conversation. As such, in some embodiments, the digital conversation is not affected or disturbed by the system or method of the disclosure.

In some embodiments, the messaging platform may be one component of an online network. The online network may provide other functionality that may be integrated with the messaging platform and/or the disclosure or the other functionality may operate independently with respect to the disclosure.

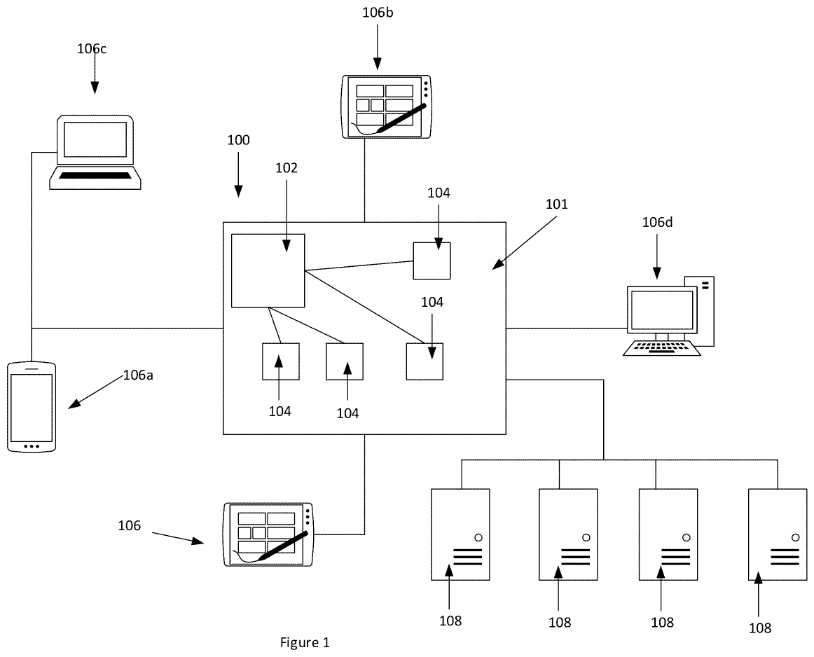

Turning to FIG. 1, a system for providing digital content within a digital conversation based on messages within the conversation in an operational environment is shown. The system 100 includes a processor 102 for communicating with or for executing a set of modules 104 that provide functionality for artificial intelligence (AI) powered conversations or for providing digital content within a digital conversation based on messages within the conversation. In some embodiments, the system 100 is stored within a server 101.

The system 100 communicates with a set of communication, or user communication, devices 106 that are associated with individuals that use these devices 106 for having digital conversations with other individuals. Examples of communication devices 106 include, but are not limited to, Smartphones 106a, tablets 106b, laptops 106c, desktops 106d and the like. For embodiments where the system is integrated within or with a messaging platform, the communication devices 106 may be mobile or portable communication devices, and the users of the messaging platform access the platform through an application or app executing or stored on their mobile devices. In these embodiments, the communication device 106 may have stored within their memory, software, such as in the form of the application, that enables the communication device 106 to be used in AI powered conversations or digital conversations. In other embodiments, the communication devices 106 may be used to log into an online network or application that is stored within the system 100 or to login the system itself in order to enable conversations between communication devices 106. It is assumed that individuals are able to play video or digital content on their communication devices 106.

The system 100 may be further connected to, and in communication with, other servers 108 that store social medial platforms such as, but not limited to Youtube™, TikTok™, Instagram™ or other forms of digital content such as, but not limited to, jpegs, memes, gifs and the like. These servers 108 may be associated or managed by third parties that provide video content for distribution through the system to the individuals who are having the digital conversation. The server provides a feed of video content to the users of the platform.

Communication between the system 100 and the communication devices 106 and/or servers 108 is over a network using TCP/IP; Ethernet; ATM SONET/SDNET; over air; copper wires; optical fiber or any other physical support capable of carrying data. The servers, 108 which may be external to the system, may be seen as social media platform servers that store or provide access to digital media content that has been stored or uploaded to the social media platform.

In one embodiment, the network is the Internet and the communication devices 106 may be connected to the network, or Internet, in a variety of ways, such as, but not limited to, via a wired network, via a cellular network, via Wi-Fi, or via Bluetooth™. A skilled person will understand that the server 101 may include multiple servers in a cluster or other similar shared-processing or distributed-processing architectures, whether in a single location or over cloud computing.

In some embodiments, the online network or the messaging platform integrates social media with video content distribution. For example, the messaging platform enables individuals to have a conversation with one another and to allow individuals to integrated or embed video content within the conversation without having to leave the conversation to access other social media platforms or services.

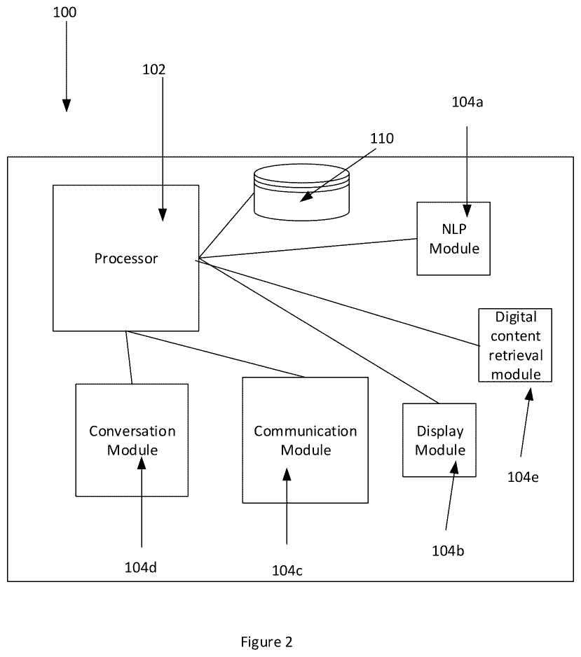

Turning to FIG. 2, a schematic diagram of the system is shown. As can be seen in FIG. 2, the system includes the processor 102 which is connected to, or in communication with the set of modules 104. The system 100 may further include the database 110 that stores data or information that may be accessed by the processor 102. In some embodiments, the database 110 stores digital content that may be accessed by the processor for embedding within a digital conversation or may store messages from the digital conversation. The database 110 may also store links to other servers (such as one associated with other social media platforms) that store digital media content that can be embedded or integrated within a digital conversation. In some embodiments, the embedding or integration of the digital media content or digital content may be performed automatically by the system. The database 110 may also be used to store other information or data for an online network that is not used for by the system 100.

In the current embodiment, the set of modules 104 include a natural language processing (NLP) module 104a, a display module 104b, a communication module 104c and a conversation model 104d. Although connections are only shown between the processor 102 and the modules 104 and the processor 102 and the database 110, it is understood that the modules 104 may be connected, or in communication, with each other and with the database 110.

In one embodiment, the conversation module 104d provides the functionality for communication devices 106 to engage in a digital conversation with other communication devices 106. For example, the conversation module 104d may enable SMS messaging between communication devices 106 or may enable a digital conversation, separate from or via a messaging platform, for the individuals to exchange messages using their communication devices 106. In other words, the conversation module 104d may provide the backbone to implement the functionality enabling individuals to communicate with each other via a digital conversation. The conversation module may also monitor, receive and/or retrieve messages from the conversation and send them to the NLP module 104a.

The NLP module 104a analyzes messages (such as ones received from the conversation module 104d) that are posted or sent in the digital conversation and processes the phrases, terms and/or words within the messages to recognize, determine and/or understand the context of the message and content or information that is being conveyed within the conversation by the message. In some embodiments, the NLP module 104 may generate search terms relating to the context or content of the messages. After processing the message to determine the context and/or content of the message, this information may be transmitted by the processor 102 or the NLP module 104a to a digital content retrieval module 104e. The digital content retrieval module 104e may search the database 110 or may communicate with the other servers 108 (such as via a communication module 104c) to retrieve digital media content or links to digital media content that relate to the determined context or content of the message.

For example, if the message is “I like the Toronto Raptors™”, the NLP module 104a may process the message to determine that the individual likes basketball and, more specifically, the Toronto Raptors. In embodiments, the NLP module 104a then transmits this determination to the digital content retrieval module 104e to search the database 110 or the servers 108 for content relating to the Toronto Raptors or basketball such as, but not limited to, tickets to a basketball ball game nearby, recent online stories about the basketball or the Toronto Raptors, highlights from recent basketball games or a list of upcoming games for the Toronto Raptors. If digital content is located by the digital media content retrieval module 104e, the conversation module 104d may then embed or integrate this digital content into the digital conversation directly or with the assistance of the communication module 104c. In some embodiments, the digital content may be directly embedded or integrated within the conversation or the digital content may be transmitted as a recommendation to the individual who wrote the message allowing the individual to decide if they wish to embed or integrate this digital content, all without having to leave the digital conversation.

The communication module 104c provides the functionality to enable communication between the communication devices 106 (where the conversation module 104d provides the functionality for or structure for the digital conversation). The communication module 104c may also provide the functionality to enable communication between the processor 102 and the individual communication devices 106 and the other servers 108. The communication module 104c may use any known communication protocols to communicate with these other components. The communication module 104c may also interact with the other servers 108 to search the servers for information and to retrieve or receive digital content from these servers for embedding or integrating within a conversation or may operate with the digital content retrieval module 104e to perform this functionality. The display module 104b may generate the displays or views that are shown on a communication device during a conversation. The display module 104b may also generate the screens for displaying the digital content on the communication devices once it has been retrieved by the digital content retrieval module 104e. In other embodiments, the display module 104b may determine the type of communication device that is being used by different individuals and then formats a screen to display the digital content based on the type of communication device.

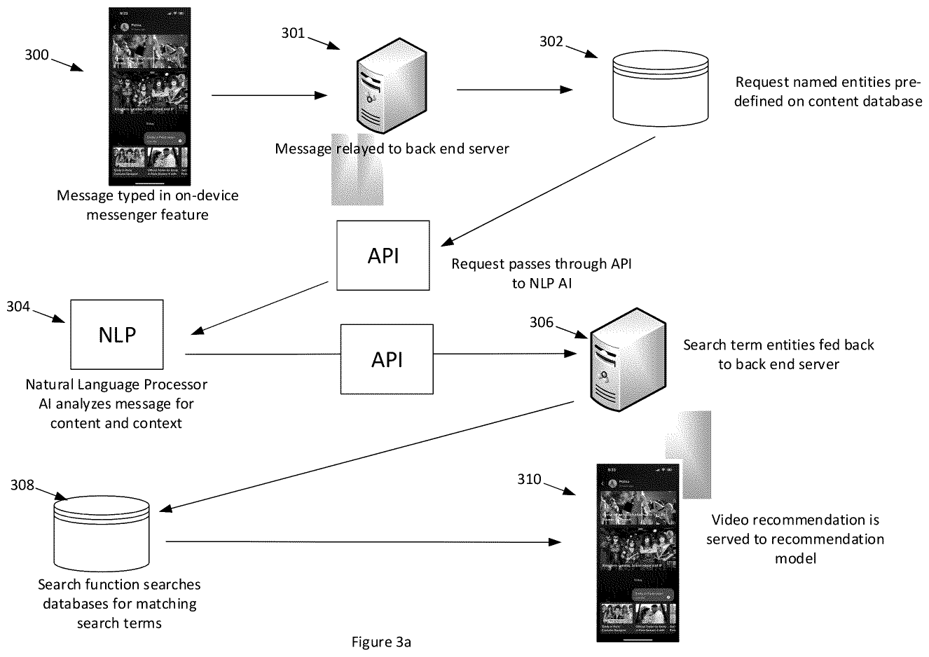

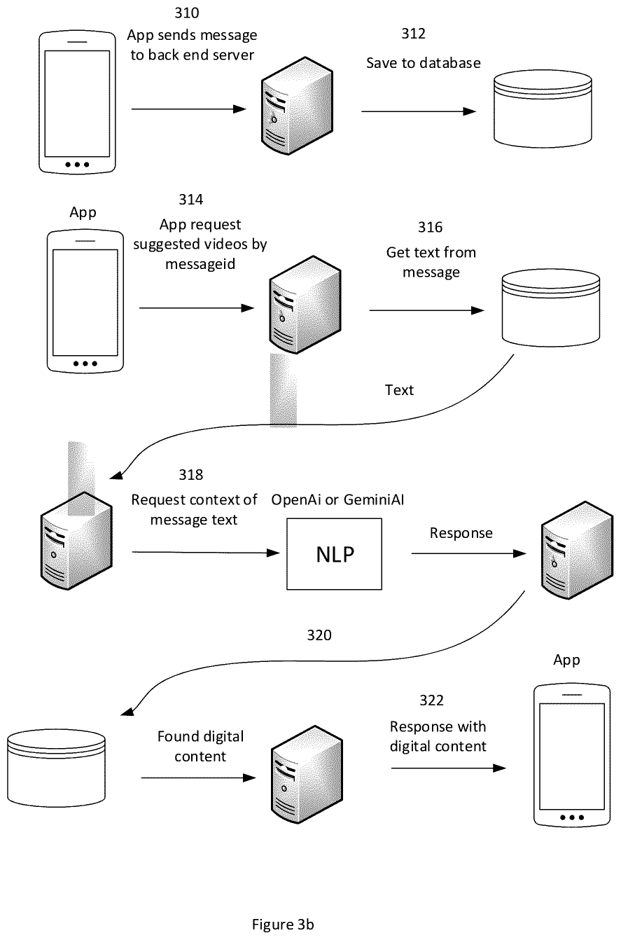

Turning to FIG. 3a, a series of schematic images showing a method of providing digital content within a digital conversation based on messages within the conversation is shown. Upon initiation of a conversation between at least two communication devices, the system receives or monitors the messages being typed within a conversation (300), such as via the conversation module. It is understood that the initiation of the digital conversation may or may not be the start of the method of the disclosure. Messages that are inputted into the conversation are then relayed or transmitted to a back end server (301) associated with the system such as by the conversation module or by an application.

The system then performs a request for named entities that have been pre-defined within a system database (302). In one embodiment, this includes using NLP features (or the NLP module) to extract named entities from the conversation text. Using the named entity extraction (NER) functionality (which may be part of the NLP module), the request for named entities extracts the named entities from the conversation text.

The system then performs NLP on the messages (304), such as via the NLP module, to determine content and/or context of the conversation. In some embodiments, the request to perform NLP on the message or messages may be passed through an application programming interface (API). The system may perform the NLP on all messages within the digital conversation or on a message or messages that an individual has requested to be processed by the NLP module; on messages that are include a threshold of words, i.e. the message must include at least 5 words; on messages that include predetermined key words or on messages that meet predetermined criteria.

The system then uses the information gathered by the NLP or the context and content of the message as determined by the NLP to communicate with servers (306). The information may be in the form of search parameters or criteria. The servers then take the gathered information or search criteria to search databases associated with the server to determine if there is any digital media content associated with the search parameters stored within the database (308). If any digital media content is located or found, the digital media content is then transmitted to the system 100 and received and processed by the system. This retrieval of digital media content and/or the processing of the digital media content may be performed by the digital content retrieval module. In other embodiments, the system performs a search within the system database to determine if there are any records or links associated with or matching the information from the determination. In some embodiments, this may be performed as a matching with inputs in a look-up table, using keyword or text matching or using a trained machine learning module to recognize closely related terms in the database to the search terms being provided by previous steps in the process.

The system then integrates or embeds the digital content into the conversation (310). In one embodiment, the digital content is integrated in the form of digital content recommendations to the individual who typed the message such that the individual can then easily insert the digital content into the conversation. This may be performed by taking items returned from the search and then formatted for presentation in the application or the conversation. This includes, but is not limited to, a thumbnail of the video, a description or other metadata such as data or production, source credits etc.

In another embodiment, the digital content is integrated in the form of links that the individual can easily insert into the digital conversation so that other individuals in the digital conversation can access the link via their own communication devices to display the digital content. In another embodiment, the digital content may automatically be inserted or integrated within the conversation by the system whereby all of the individuals can have access to the digital content. In some embodiments, where the digital content is transmitted initially to the individual who typed the message, the individual can decide which, if not all, of the individuals in the digital conversation should be provided with the digital content.

Turning to FIG. 3b, a set of schematic images showing another embodiment of a method of providing digital content within a digital conversation based on messages within the conversation is shown. In the embodiment of FIG. 3b, it is assumed that the conversation between the communication devices of the individuals is taking place within a messaging platform, such as part of an online network, that requires the individuals to logon to the online network. As such, the conversation takes place or is enabled by a messaging functionality provided by the system whereby each of the messages is automatically saved to the system database. In one embodiment, all of the messages within the digital conversation are stored within the system database and assigned a message identification number. In one embodiment, the database tracks the storage of messages and their corresponding message identification number in a table stored within the database.

As the conversation is taking place, each of the messages within the conversation are monitored by the conversation module and transmitted to a server associated with the system (310) and then stored in a database (312). As discussed above, each of the messages may be assigned a messageid.

As the conversation is going on, an individual may wish to search for digital media content associated with one of the message within the conversation. The individual may then submit a request to the system to locate videos associated with one of the messages (based on the messageid) (314) whereby a request is received by the system to retrieve digital content related to a message within the conversation.

The request is received by the system which then retrieves the message (associated with the messageid) from the system database (316). In one embodiment, the request from the individual includes the message identification number such that the system can retrieve the corresponding message from the database. The message is the processed, such as via the NLP module, to determine content and/or context of the message (318). After processing the message, the system then searches the system database for any digital content (320) that relates to the processed message which relates to the context or content of the message as determined by the NLP module. The digital content may be in the form of a video, a link to a video, a meme or a link to digital content. Any relevant digital content is then retrieved from the database and then inserted into the conversation (322). In some embodiments, if there is only a single piece of digital content retrieved, the digital content may be inserted directly into the conversation where each of the conversation participants are able to see the digital content. Alternatively, the digital content, whether one or many results, may be provided to the individual who typed the message that was processed to allow the individual to determine if they wish to include the digital content in the conversation. The digital content may be transmitted to the individual via a recommendation window. In some embodiments, the digital content may be a video that automatically plays within the conversation. In other embodiments, the digital content may be a link to a video that can be played within the conversation. In yet further embodiments, the digital content may be a link that any individual may click on and then be taken to another social medial platform where the digital content can be viewed.

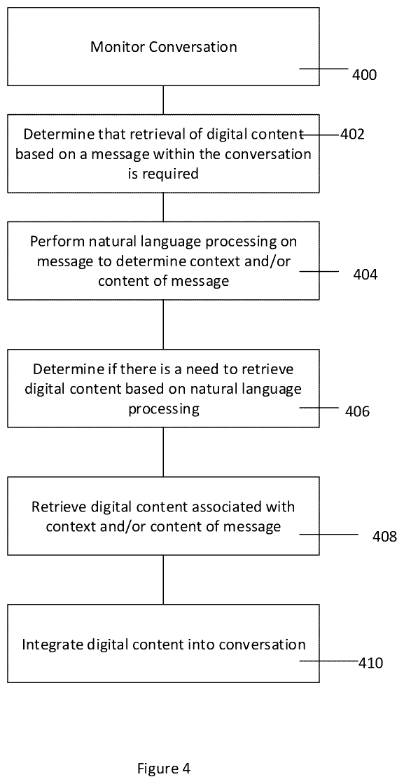

Turing to FIG. 4, a flowchart showing another method of providing digital content within a digital conversation based on messages within the conversation is shown. In this embodiment, it is assumed that a conversation has already been established and is happening between at least two individuals. As discussed above, the conversation is enabled via communication devices communicating with each other such as within a messaging platform that is associated with the system of the disclosure.

Initially, the system monitors the conversation (400). As the system monitors the conversation, in some embodiments, the system may store some or all of the messages from the conversation into a database. In other embodiments, all of the messages may automatically stored if the conversation is occurring over a messaging platform associated with the system. In other embodiments, the system may only store messages which include a predetermined number of words or includes at least one of a set of predetermined words.

As the conversation proceeds, the system may determine that there is a need to retrieve digital content based on a message within the conversation (402). In some embodiments, the determination may be via a request by one of the communication devices to retrieve digital content based on a specific message written by the individual within the digital conversation. For example, the individual may perform an action on the message indicating to the system that the individual is requesting digital content to be retrieved based on that message. In other embodiments, the system may use NLP to process each message within the conversation to determine if there is a need to retrieve digital content. In yet other embodiments, the system may determine there is a need to retrieve digital content based on words that are included within a message or other predetermined criteria.

After determining the need to retrieve digital content, the system then processes the message (404) using NLP to determine the content and context of the message. In some embodiments, the system may process each of the messages in a conversation to determine the content and context of each message. In other embodiments, the system only processes selected or requested messages from the conversation. Processing of the message or messages may result in a set of search criteria or search parameters.

Based on the processing, the system may determine if there is a need to retrieve digital content (406). In embodiments where the individual has specifically requested digital content to be retrieved based on a message, the system does not need to determine if there is a need as that has already been requested. In other embodiments where the system is processing each message, the system may determine there is no need to retrieve digital content for a specific message based on the context or content of the message so that the system does not have to experience unnecessary processing time which may affect operation of the system such as in situations where the message is a single word.

If there is a need to retrieve digital content, the system then retrieves the digital content based on the context and/or content of the message (or search parameters) that has been processed (408). In some embodiments, the system may generate a set of search criteria based on the processed context and/or content. The system may then access a database to compare the search criteria with entries within the database to determine if there is any stored digital content that matches the search criteria. If there are matches, the system then retrieves this digital content from the database. In other embodiments, the system may perform a search over the Internet or a social media platform using the search criteria to determine if any digital media content can be located. In yet other embodiments, the system may communicate with other servers requesting digital content from these servers based on the search parameters. Any relevant digital content may then be returned by the servers to the system. The system then integrates the digital content into the conversation (410). As outlined above, in some embodiments, the digital content can be integrated or embedded directly into the conversation or the digital content may be provided to the individual who wrote the message in a recommendation window or pane such that the individual can review the digital content to determine if they wish to integrate or embed the digital content into the conversation. If the individual decides to integrate the information, the individual may simply click on the recommendation and the system then integrates or embeds the digital content into the conversation or transmits the digital content to selected individuals in the digital conversation. The digital content may be embedded in the form of a link that the other individuals in the conversation can click to review the digital content. In other embodiments, the digital content, such as when in a video format, may automatically play within the conversation for all individuals to watch. In other embodiments, the digital content, such as in the form or a meme or picture, may be embedded into the conversation for all the individuals to look at.

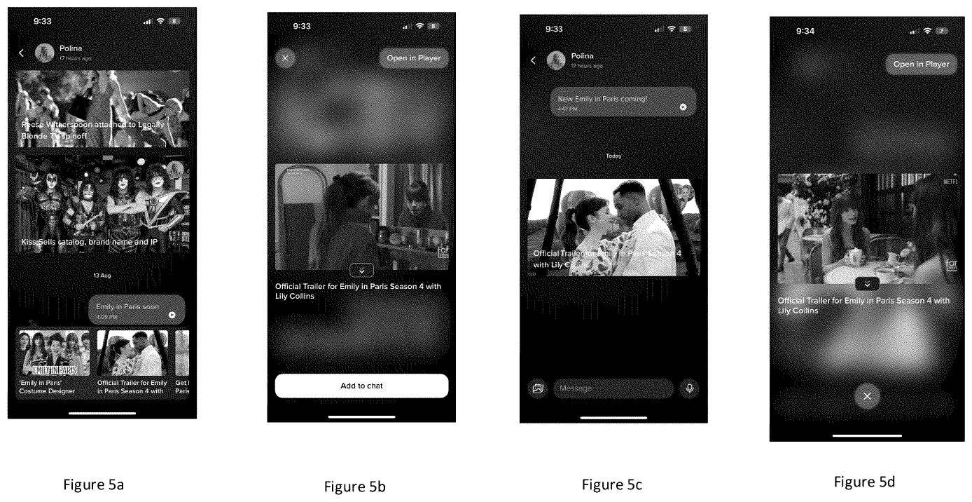

FIGS. 5a to 5d are example screenshots that may be displayed on a communication device according to the disclosure.

In some embodiments, the communication between the system and the communication devices of the individuals is via known communication protocols. If the communication devices are logged into an online network stored in the system server, the communication devices may include applications that enables the communication device to utilize the messaging platform of the online network.

In one embodiment, the NLP is performed by known NLP engines, however, it is understood that the NLP may also be performed by a NLP processor that is associated with the online network. In yet other embodiments, the database that stores the digital content may be regularly updated to include new digital content that has been stored or saved on other servers or within other databases. In this embodiment, the processor of the system may regularly retrieve new digital content and then store the digital content or links to the new digital content into the database. Alternatively, the system may include a subscription to or relationship with different social media platforms where new digital content is regularly transmitted to the database by the social medial platforms for storage within the database.

In the preceding description, for purposes of explanation, numerous details are set forth in order to provide a thorough understanding of the embodiments. However, it will be apparent to one skilled in the art that these specific details may not be required. In other instances, well-known structures may be shown in block diagram form in order not to obscure the understanding. For example, specific details are not provided as to whether elements of the embodiments described herein are implemented as a software routine, hardware circuit, firmware, or a combination thereof.

Embodiments of the disclosure or components thereof can be provided as or represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor or controller to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor, controller or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

What is claimed is:

1. A method for providing digital content within a digital conversation based on messages within the digital conversation comprising:
processing a selected message within the digital conversation using natural language processing (NLP) to determine a context or content of the selected message;
retrieving digital content associated with the context or content of the selected message; and
embedding the digital content into the digital conversation.

2. The method of claim 1 wherein embedding the digital content into the digital conversation comprises:
providing a list of the digital content to an individual associated with the selected message;
receiving a selection of digital content from the list of the digital content; and
integrating the selected digital content into the digital conversation.

3. The method of claim 1 wherein processing a selected message comprises:
saving each message within the digital conversation;
assigning a message identification for each message;
receiving a request to process a message based on the message identification; and
processing the identified message using NLP.

4. The method of claim 1 wherein embedding the digital content into the digital conversation comprises:
playing the embedded digital content within the digital conversation.

5. The method of claim 1 wherein embedding the digital content into the digital conversation comprises:
integrating the embedded digital content within the digital conversation.

6. The method of claim 1 wherein retrieving digital content associated with the context or content of the selected message comprises:
accessing a server storing digital content associated with the context or content of the selected message;
requesting the digital content from the server; and
receiving the digital content from the server.

7. The method of claim 1 wherein the digital content is at least one of video content; digital content; jpegs; memes; or gifs.
